(19) United States
(12) Patent Application Publication
(10) Pub. No.: US 2006/0066778 A1
(43) Pub. Date: Mar. 30, 2006

(54) Display device having controlled hue of specular reflection light

(75) Inventor: Keiichi Miyazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/229,620

(22) Filed: Sep. 20, 2005

(30) Foreign Application Priority Data
Sep. 24, 2004 (JP) P. 2004-276649

(51) Int. Cl. G02F 1/1335

(52) U.S. Cl. 349/106

(57) ABSTRACT

A display device such as a liquid crystal display device is provided in which a phenomenon that specular reflection light due to an ambient light source takes on various colors is corrected, and the specular reflection light is set to an arbitrary designated hue such as a gray or a preferred hue in some cases. In a liquid crystal display device or the like, a color correction colored filter layer for setting the color of specular reflection light to a neutral gray or an arbitrary hue is disposed. The color correction colored filter layer may be integrated with an antireflection film, a polarizing film, or a liquid crystal panel.

This application is based on Japanese Patent application JP 2004-276649, filed Sep. 24, 2004, the entire content of which is hereby incorporated by reference. This claim for priority benefit is being filed concurrently with the filing of this application.

### BACKGROUND OF THE INVENTION

1. Technical Field of the Invention

The present invention relates to a display device such as a liquid crystal display device in which a color correction colored filter layer is disposed, whereby coloring of specular reflection light from the display panel is corrected, and controlled to a neutral gray or a preferred hue.

2. Description of the Related Art

In a related art display device such as a liquid crystal display device, it is known that, particularly in a black display, conspicuous specular reflection light due to an ambient light source is not always neutral gray and takes on various colors.

As a result, the display image quality of the liquid crystal display device is impaired.

A similar phenomenon may occur more or less in other display devices such as a plasma display, an organic EL display, a CRT, a fluorescent display tube, and a field emission display.

On the other hand, in the related art, the followings are taken as a countermeasure against degradation of display contrast due to reflection of external light from the surface of a panel. An antireflection layer is formed on the surface of a panel, an ND filter is disposed in front of a panel in order to absorb and reduce reflection light from a fluorescent face, or a color adjustment filter for suppressing the brightness of green emission is disposed in front of a panel. In an emission type display device, the brightness of green which has the highest visibility is large, and a display screen tends to be greenish. In order to correct the color balance of display colors, the disposition of the color adjustment filter is conducted.

In this case, a configuration in which the color adjustment filter or the ND filter is disposed in front of a display panel, and then an antireflection filter is stacked thereon is employed. Therefore, reflection due to refraction of external light occurs between the filters, thereby causing problems in that a Moire pattern appears, and that the antireflection effect is reduced and the contrast is lowered. In order to solve the problems, JP-A-10-26704 discloses an antireflection filter in which a surface hardened layer of a transparent resin is formed on the surface of a transparent plastic film, and a multilayer antireflection layer is disposed thereon, and in which the transparent resin in the surface hardened layer is colored in a neutral gray or a color which suppresses transmission of green light.

In this case also, however, only the functions of preventing the contrast from being lowered, and correcting the color balance of display colors are performed. There is no teaching about the concept of correction of coloring of specular reflection light.

The inventor has noted that a phenomenon that specular reflection light takes on various colors is deemed to be caused by the following reason. In a liquid crystal display device, for example, the color of specular reflection light seems to be determined mainly by a combination of (1) the surface spectral reflectivity of the liquid crystal display device (particularly, in the case where a antireflection layer is disposed), (2) the spectral transmittance of a polarizing film, and (3) the spectral reflectivity at the surface of an RGB color filter/mask. However, the display device is produced while (1), (2), and (3) are independently designed. As a result of a combination of (1), (2), and (3), therefore, the color of specular reflection light seems to take on various colors.

Consequently, the inventor has noticed that, in, for example, a liquid crystal display device, a color correction colored filter layer is disposed in any position between the surface on the observation side and an RGB color filter layer in order to change the color of specular reflection light, whereby the color of specular reflection light ought to be set to a neutral gray or an arbitrary hue, and accomplished the invention.

### SUMMARY OF THE INVENTION

It is an object of the invention to provide a display device such as a liquid crystal display device in which a phenomenon that specular reflection light due to an ambient light source takes on various colors is corrected, and the specular reflection light is set to an arbitrary designated hue such as a gray or a preferred hue in some cases.

According to the invention, the above-discussed problem is solved by the following means.

(1). A display device comprising a color correction colored filter layer for setting a color of specular reflection light to an arbitrary hue.

(2). The display device according to (1), wherein the device comprises a color correction colored filter layer for setting a color of specular reflection light to a neutral gray.

(3). A liquid crystal display device comprising a color correction colored filter layer for setting a color of specular reflection light to an arbitrary hue.

(4). The liquid crystal display device according to (3), wherein the device comprises a color correction colored filter layer for setting a color of specular reflection light to a neutral gray.

(5). The liquid crystal display device according to (3) or (4), wherein the device comprises an antireflection layer, a polarizing film, an RGB color filter, and a liquid crystal layer.

(6). The liquid crystal display device according to (5), wherein the color correction colored filter layer is disposed between the polarizing film and the RGB color filter.

(7). The liquid crystal display device according to (5), wherein the color correction colored layer is disposed between the antireflection layer and the polarizing film.

(8). The liquid crystal display device according to (5), wherein the color correction colored filter layer is directly attached to an antireflection film having the antireflection layer to form an integrated antireflection film.

(9). The liquid crystal display device according to (5), wherein the color correction colored filter layer is directly attached to a polarizing plate having the polarizing film to form an integrated polarizing plate.

(10). The liquid crystal display device according to (5), wherein the color correction colored filter layer is directly attached to a liquid crystal panel having the RGB color filter and the liquid crystal layer to form an integrated liquid crystal panel.

(11). An antireflection film comprising a color correction colored filter layer for setting a color of specular reflection light of a liquid crystal display device to an arbitrary hue.

(12). The antireflection film according to (11), wherein the antireflection film comprises a color correction colored filter layer for setting a color of specular reflection light of a liquid crystal display device to a neutral gray.

(13). A polarizing plate comprising a color correction colored filter layer for setting a color of specular reflection light of a liquid crystal display device to an arbitrary hue.

(14). The polarizing plate according to (13), wherein the polarizing plate comprises a color correction colored filter layer for setting a color of specular reflection light of a liquid crystal display device to a neutral gray.

(15). A liquid crystal panel comprising a color correction colored filter layer for setting a color of specular reflection light of a liquid crystal display device to an arbitrary hue.

(16). The liquid crystal panel according to (15), wherein the liquid crystal panel comprises a color correction colored filter layer for setting a color of specular reflection light of a liquid crystal display device to a neutral gray.

According to the invention, the color of specular reflection light of a display device can be set to a neutral gray or an arbitrary preferred hue.

According to the invention, furthermore, an arbitrary color of specular reflection light such as a neutral gray or a preferred hue can be realized in a liquid crystal display device having any values with respect to (1) the surface spectral reflectivity (particularly, in the case where a antireflection layer is disposed), (2) the spectral transmittance of a polarizing film, and (3) the spectral reflectivity at the surface of an RGB color filter/mask.

### BRIEF DESCRIPTION OF THE DRAWINGS

FIG. 1 is a diagram showing a manner in which light of a wavelength λ from an ambient light source S(λ) irradiates a liquid crystal display device having an antireflection layer 1, a polarizing film 2, an RGB color filter 3, a liquid crystal layer 4, etc., and is reflected and absorbed by the layers.

FIG. 2 is a diagram showing that, in FIG. 1, a color correction colored filter layer 9 according to the invention is interposed between the polarizing film 2 and the RGB color filter 3.

### DETAILED DESCRIPTION OF THE INVENTION

Hereinafter, the invention will be described with taking a liquid crystal display device as an example.

As described above, a phenomenon that specular reflection light takes on various colors is deemed to be caused by the following reason. In a liquid crystal display device, for example, the color of specular reflection light seems to be determined mainly by a combination of (1) the surface spectral reflectivity (particularly, in the case where a antireflection layer is disposed), (2) the spectral transmittance of a polarizing film, and (3) the spectral reflectivity at the surface of an RGB color filter/mask. However, the display device is produced while (1), (2), and (3) are independently designed. As a result of a combination of (1), (2), and (3), therefore, specular reflection light seems to take on various colors.

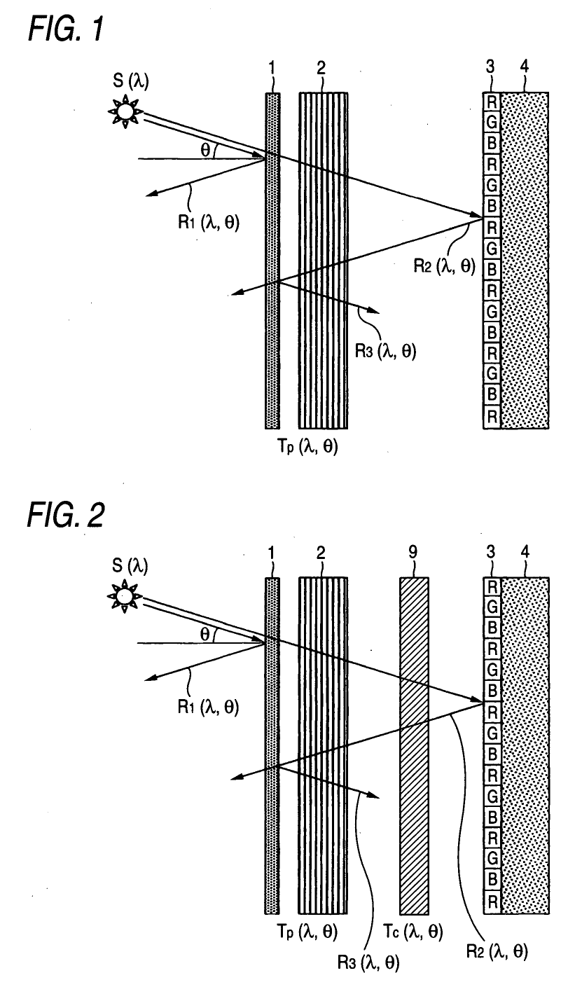

This will be described with reference to the drawings as follows (see FIG. 1).

FIG. 1 shows that light of a wavelength λ from a light source S(λ) serving as an ambient light source irradiates a liquid crystal display device having an antireflection layer 1, a polarizing film 2, an RGB color filter 3, a liquid crystal layer 4, etc.

The light of the wavelength λ emitted from the light source S(λ) is incident on the antireflection layer 1 at an incident angle θ. Only a flux R₁(λ, θ) among the total flux is reflected from the layer, and the other flux is transmitted through the layer. The light of the wavelength λ transmitted through the antireflection layer 1 is then transmitted through the polarizing film 2. At this time, a part of the light is absorbed by the polarizing film 2, and only a flux Tₚ(λ, θ) is transmitted through the film. Among the light of the wavelength λ transmitted through the polarizing film 2, thereafter, only a flux R₂(λ, θ) is reflected from the surface of the RGB color filter. Thereafter, the light of the wavelength λ reflected from the surface of the RGB color filter is transmitted again through the polarizing film 2. At this time, a part of the light is absorbed by the polarizing film 2, and only a flux Tₚ(λ, θ) is transmitted through of the film. Then, the light reaches the antireflection layer 1, only a flux R₃(λ, θ) is reflected, and the remaining flux is transmitted through the antireflection layer 1 to reach the observer in front of the liquid crystal display device.

As a result, the light which reaches as specular reflection light the observer in front of the liquid crystal display device is the total of the flux R₁(λ, θ) and the transmitted light.

Namely, specular reflection light Rₐₗₗ(λ, θ)₀ can be expressed by:

$${{R}_{a11} ( λ , θ )}_{0} = \begin{matrix}{R}_{1} ( λ , θ ) + \{ 1 - {R}_{1} ( λ , θ ) \} \times {R}_{2} ( λ , θ ) \times \\ {{T}_{p} ( λ , θ )}^{2} \times \{ 1 - {R}_{3} ( λ , θ ) \}\end{matrix} \qquad ( 1 )$$

These terms affect each other. As a result, the specular reflection light Rₐₗₗ(λ, θ)₀ does not always appear as a neutral gray, but takes on various colors.

Next, a case where, for example, a color correction colored filter layer 9 according to the invention is interposed between the polarizing film 2 and the RGB color filter 3 will be considered (see FIG. 2).

In FIG. 2, in the same manner as FIG. 1, light of the wavelength λ from the light source S(λ) serving as an ambient light source irradiates a liquid crystal display device having the antireflection layer 1, the polarizing film 2, the RGB color filter 3, the liquid crystal layer 4, etc. However, the liquid crystal display device is different in that the color correction colored filter layer 9 is interposed between the polarizing film 2 and the RGB color filter 3.

In this case, the light of the wavelength λ emitted from the light source S(λ) is incident on the antireflection layer 1 at the incident angle θ, only the flux R₁(λ, θ) among the total flux is reflected from the layer, the other flux is transmitted through the layer, the light of the wavelength λ transmitted through the antireflection layer 1 is then transmitted through the polarizing film 2, a part of the light is absorbed by the polarizing film 2, and only the flux Tₚ(λ, θ) is transmitted through of the film. This is identical with FIG. 1.

Then, the light of the wavelength λ transmitted through the polarizing film 2 is transmitted through the color correction colored filter layer 9. At this time, a part of the light is absorbed by the color correction colored filter layer 9, and only a flux T_{c}(λ, θ) is transmitted through the layer.

Among the light of the wavelength λ transmitted through the color correction colored filter layer 9, only a flux R₂(λ, θ) is reflected from the surface of the RGB color filter. The light of the wavelength λ reflected from the surface of the RGB color filter is transmitted again through the color correction colored filter layer 9 and the polarizing film 2. At this time, a part of the light is absorbed by the color correction colored filter layer 9, and only a flux T_{c}(λ, θ) is transmitted through of the layer. Furthermore, a part of the light is absorbed by the polarizing film 2, and only a flux Tₚ(λ, θ) is transmitted through of the film. Then, the light reaches the antireflection layer 1, only a flux R₃(λ, θ) is reflected, and the remaining flux is transmitted through the antireflection layer 1 to reach the observer in front of the liquid crystal display device.

Specular reflection light Rₐₗₗ(λ, θ)₁ in this case can be expressed by:

$${{R}_{a11} ( λ , θ )}_{1} = \begin{matrix}{R}_{1} ( λ , θ ) + \{ 1 - {R}_{1} ( λ , θ ) \} \times {R}_{2} ( λ , θ ) \times \\ {{T}_{p} ( λ , θ )}^{2} \times {{T}_{c} ( λ , θ )}^{2} \times \{ 1 - {R}_{3} ( λ , θ ) \}\end{matrix} \qquad ( 2 )$$

In the invention, the color correction colored filter layer 9 having a transmittance of T_{c}(λ, θ) by which the specular reflection light Rₐₗₗ(λ, θ)₁ in this case is caused to take on, for example, a neutral gray is disposed.

The hue is not restricted to a neutral gray. The transmittance T_{c}(λ, θ) of the color correction colored filter layer 9 may be determined so that the specular reflection light Rₐₗₗ(λ, θ)₁ has an arbitrary preferred hue.

When expression (2) is solved for T_{c}(λ, θ), the following expression is obtained:
T_{c}(λ, θ)={(Rₐₗₗ(λ, θ)₁−R₁(λ, θ))/(1−R₁(λ, θ)×R₂(λ, θ)×(1−R₃(λ, θ))×Tₚ(λ, θ)²)^{1/2} (3)

When R₁(λ, θ), R₂(λ, θ), R₃(λ, θ) and Tₚ(λ, θ) are known, the transmittance T_{c}(λ, θ) of the color correction colored filter layer 9 is determined by determining Rₐₗₗ(λ, θ)₁ of the target specular reflection light.

When the transmittance T_{c}(λ, θ) of the color correction colored filter layer 9 is determined in this way, the color of the specular reflection light of the liquid crystal display device can be set to a target neutral gray or an arbitrary preferred hue.

In the above description, the color correction colored filter layer 9 is placed between the polarizing film 2 and the RGB color filter 3. Alternatively, the layer may be placed between the antireflection layer 1 and the polarizing film 2.

In the above, the liquid crystal display device has been described as the display device. The same is applicable to other kinds of display devices.

The color correction colored filter layer 9 may be directly attached to an antireflection film having the antireflection layer 1, to form an integrated antireflection film.

The color correction colored filter layer 9 may be directly attached to a polarizing plate having the polarizing film 2, to form an integrated polarizing plate.

The color correction colored filter layer 9 may be directly attached to a liquid crystal panel having the RGB color filter 3, the liquid crystal layer 4, etc., to form an integrated liquid crystal panel.

The color correction colored filter layer may be produced by a usual method of producing a colored filter.

For example, the layer is produced in the following manner. One or more kinds of dyes or pigments having an adequate spectral characteristic are selected from various color materials so that the color correction colored filter layer has the above-mentioned objective spectral characteristic. An adequate amount of the selected color material is dispersed in an appropriate binder solution, and the dispersion solution is applied to a substrate.

Preferably, a paste-like pigment dispersion solution having a viscosity of about 10 to 50 mPa·S may be used. The dispersion solution is applied to a glass substrate by an adequate method such as the spin coat method. In the spin coat method, an adequate amount of the solution is dropped onto a middle portion of the substrate, and the solution is spread while rotating the substrate, thereby coating the substrate. The film thickness is adequately adjusted by the number of rotations of the substrate and the rotation time period, whereby the color density of the filter layer can be controlled. After the coating process, the substrate is baked at 200° C. for about 1 Hr. in order to harden the film.

### EXAMPLES

As a liquid crystal display device, a commercially available product was used. In the liquid crystal display device, specular reflection light due to an ambient light source took on a slightly reddish color.

The light of the backlight used in the liquid crystal display device is typified by three bright lines. Therefore, spectral characteristics for the terms of R₁, R₂, R₃, Tₚ, and Rₐₗₗ were measured with using wavelengths λ=435 nm (B), 540 nm (G), and 610 nm (R). Results of the measurements are listed in Table A blow. In the measurements, the incident angle was set to θ=5° which is used as an incident angle for evaluating the performance of an antireflection film.

TABLE A
The color correction colored filter layer 9 (T_{c}) is not disposed.

| | (B) | (G) | (R) |
|---|---|---|---|
| R₁ | 3% | 0.5% | 0.5% |
| R₂ | 10% | 30% | 50% |
| R₃ | 3% | 0.5% | 0.5% |
| T_{P} | 30% | 40% | 40% |
| Rₐₗₗ | 3.8% | 5.2% | 8.4% |

By contrast, in place of the antireflection film 1 used in the liquid crystal display device, an antireflection film having a color correction colored filter layer was produced, and also Rₐₗₗ was measured. In the antireflection film, the color correction colored filter layer 9 (T_{c}) having the following characteristics is directly attached to and integrated with the antireflection film 1 (R₁) having the following characteristics. Results of the measurements are as follows.

TABLE B
The color correction colored filter layer (T_{c}) is disposed.

| | (B) | (G) | (R) |
|---|---|---|---|
| R₁ | 3% | 1.5% | 2.5% |
| R₂ | 10% | 30% | 50% |
| R₃ | 3% | 0.5% | 0.5% |
| T_{P} | 30% | 40% | 40% |
| T_{c} | 100% | 84% | 65% |
| Rₐₗₗ | 3.8% | 3.8% | 3.8% |

The above results show that the gray balance of Rₐₗₗ is corrected by the existence of the color correction colored filter layer 9 (T_{c}). It was ascertained that the color of reflection light is corrected to a gray.

The balance of Rₐₗₗ can be corrected to an arbitrary color other than a gray, by changing T_{c}.

In the above, the correction was conducted with respect to only the three wavelengths of B, G, and R. In order to correct the balance more correctly, it is desired to conduct correction at intervals of 10 nm, or preferably at intervals of a shorter wavelength. When metamerism in which even different spectral distributions look visually identical to each other is used, it is not necessary to conduct correction at all wavelengths, and colorimetric coincidence in chromaticity or chromatic coordinate may be employed.

What is claimed is:

1. A display device comprising a color correction colored filter layer for setting a color of specular reflection light to an arbitrary hue.

2. The display device according to claim 1, wherein the device comprises a color correction colored filter layer for setting a color of specular reflection light to a neutral gray.

3. A liquid crystal display device comprising a color correction colored filter layer for setting a color of specular reflection light to an arbitrary hue.

4. The liquid crystal display device according to claim 3, wherein the device comprises a color correction colored filter layer for setting a color of specular reflection light to a neutral gray.

5. The liquid crystal display device according to claim 3, wherein the device comprises an antireflection layer, a polarizing film, an RGB color filter, and a liquid crystal layer.

6. The liquid crystal display device according to claim 5, wherein the color correction colored filter layer is disposed between the polarizing film and the RGB color filter.

7. The liquid crystal display device according to claim 5, wherein the color correction colored layer is disposed between the antireflection layer and the polarizing film.

8. The liquid crystal display device according to claim 5, wherein the color correction colored filter layer is directly attached to an antireflection film having the antireflection layer to form an integrated antireflection film.

9. The liquid crystal display device according to claim 5, wherein the color correction colored filter layer is directly attached to a polarizing plate having the polarizing film to form an integrated polarizing plate.

10. The liquid crystal display device according to claim 5, wherein the color correction colored filter layer is directly attached to a liquid crystal panel having the RGB color filter and the liquid crystal layer to form an integrated liquid crystal panel.

11. An antireflection film comprising a color correction colored filter layer for setting a color of specular reflection light of a liquid crystal display device to an arbitrary hue.

12. The antireflection film according to claim 11, wherein the antireflection film comprises a color correction colored filter layer for setting a color of specular reflection light of a liquid crystal display device to a neutral gray.

13. A polarizing plate comprising a color correction colored filter layer for setting a color of specular reflection light of a liquid crystal display device to an arbitrary hue.

14. The polarizing plate according to claim 13, wherein the polarizing plate comprises a color correction colored filter layer for setting a color of specular reflection light of a liquid crystal display device to a neutral gray.

15. A liquid crystal panel comprising a color correction colored filter layer for setting a color of specular reflection light of a liquid crystal display device to an arbitrary hue.

16. The liquid crystal panel according to claim 15, wherein the liquid crystal panel comprises a color correction colored filter layer for setting a color of specular reflection light of a liquid crystal display device to a neutral gray.
